(19) United States
(12) Patent Application Publication
(10) Pub. No.: US 2011/0129739 A1
(43) Pub. Date: Jun. 2, 2011

(54) AIR SECONDARY BATTERY

(75) Inventor: Shinji Nakanishi, Mishima-shi (JP)

(73) Assignee: TOYOTA JIDOSHA KABUSHIKI KAISHA, Toyota-shi (JP)

(21) Appl. No.: 12/675,951

(22) PCT Filed: Nov. 27, 2008
(86) PCT No.: PCT/JP2008/071542

§ 371 Date: Apr. 20, 2010

(51) Int. Cl. H01M 8/22

(52) U.S. Cl. 429/405

(57) ABSTRACT

A main object of the present invention is to provide an air secondary battery that can lower a charging voltage in an air secondary battery using a nonaqueous liquid electrolyte. The object is attained by providing an air secondary battery comprising: an air cathode having an air cathode layer containing a conductive material and an air cathode current collector that collects a current of the air cathode layer, an anode having an anode layer containing an anode active material and an anode current collector that collects a current of the anode layer and a nonaqueous liquid electrolyte that conducts a metal ion between the air cathode layer and the anode layer; wherein the air cathode current collector is formed of a carbon material and the nonaqueous liquid electrolyte contains a sulfonimide salt.

### TECHNICAL FIELD

The present invention relates to an air secondary battery using a nonaqueous liquid electrolyte and more specifically relates to an air secondary battery that can reduce a charging voltage.

### BACKGROUND ART

An air secondary battery using a nonaqueous liquid electrolyte is a secondary battery that uses air (oxygen) as a cathode active material and has advantages in that an energy density is high and miniaturization and weight saving are readily achieved. Accordingly, an air secondary battery is gathering attention as a high capacity secondary battery superior to a lithium secondary battery that is at present in wide use.

Such an air secondary battery includes, for example, an air cathode layer that has a conductive material (such as carbon black), a catalyst (such as manganese dioxide) and a binder (such as polyvinylidene fluoride); an air cathode current collector that collects a current of the air cathode layer; an anode layer that has and an anode active material (such as metal Li); an anode current collector that collects a current of the anode layer; and a nonaqueous liquid electrolyte conducts metal ions (such as Li ions).

A metal mesh current collector has been used as an air cathode current collector. For example, in Patent Document 1, as an air cathode of an air battery using a nonaqueous electrolyte, an air cathode obtained by pressure bonding or coating a mixture made of carbon, a catalyst, and a binder on a metal mesh current collector is disclosed. Furthermore, as materials of the air cathode current collector, metals including stainless, nickel, aluminum, iron, and titanium are disclosed.

In Patent Document 2, an aluminum air battery that uses not a nonaqueous liquid electrolyte but an aqueous liquid electrolyte is disclosed. Therein, it is disclosed to use a carbon paper as a substrate of a cathode catalytic electrode. Furthermore, also in Patent Document 3, an aluminum air battery that uses not a nonaqueous liquid electrolyte but an aqueous liquid electrolyte is disclosed. Therein, it is disclosed to use a conductive thin carbon cloth as an air cathode current collector.
Patent Document 1: Japanese Patent Application Laid-Open (JP-A) No. 2005-15737
Patent Document 2: JP-A No. 2004-327200
Patent Document 3: U.S. Pat. No. 4,248,682

### DISCLOSURE OF THE INVENTION

### Problems to be Solved by the Invention

In an air secondary battery using a nonaqueous liquid electrolyte, a metal air cathode current collector has been used. However, there is a problem that a metal air cathode current collector tends to be readily corroded. The present inventors have confirmed that the problem of corrosion can be overcome by use of not a metal air cathode current collector but an air cathode current collector made of a carbon material. However, when the carbonaceous air cathode current collector is used, a new problem that, in comparison with a case where a metal air cathode current collector is used, a charging voltage becomes higher has come up.

The present invention was performed in view of the problems and primarily intends to provide, in an air secondary battery using a nonaqueous liquid electrolyte, an air secondary battery that can reduce a charging voltage.

### Means for Solving the Problem

In order to solve the problems, the present inventors studied devotedly and found that when a nonaqueous liquid electrolyte that contains a sulfonimide salt is used, even in the case where an air cathode current collector made of a carbon material is used, a charging voltage can be reduced. The present invention was achieved based on such findings.

That is, the invention provides an air secondary battery, comprising: an air cathode having an air cathode layer containing a conductive material and an air cathode current collector that collects a current of the air cathode layer; an anode having an anode layer containing an anode active material and an anode current collector that collects a current of the anode layer; and a nonaqueous liquid electrolyte that conducts a metal ion between the air cathode layer and the anode layer; wherein the air cathode current collector is formed of a carbon material; and the nonaqueous liquid electrolyte contains a sulfonimide salt.

According to the invention, by combining an air cathode current collector constituted of a carbon material and a nonaqueous liquid electrolyte containing a sulfonimide salt, a charging voltage can be reduced.

In the invention, the sulfonimide salt is preferable to be a compound represented by a formula (I) shown below. This is because a charging voltage can be effectively reduced.

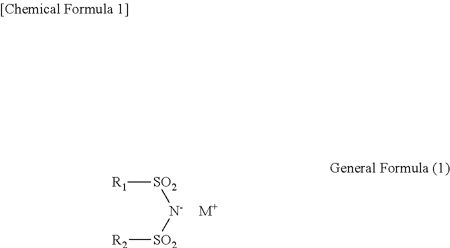

In the formula (1), M represents an alkali metal element, and R₁ and R₂, each independently represent a functional group containing a fluorine element and a carbon element. Furthermore, R₁ and R₂ may bind with each other to form a ring structure.

In the invention, the carbon material is preferable to be a carbon fiber. This is because electrons can conduct through a fiber and thereby electron conductivity is high.

In the invention, the air cathode current collector is preferable to be a carbon paper or a carbon cloth that uses the carbon fiber. This is because the gas diffusability is excellent and thereby oxygen can rapidly diffuse.

In the invention, the metal ion is preferable to be a Li ion. This is because a battery high in energy density can be obtained.

### EFFECT OF THE INVENTION

In the invention, an air secondary battery using a nonaqueous liquid electrolyte exerts an effect that a charging voltage can be reduced.

### BRIEF DESCRIPTION OF THE DRAWINGS

FIG. 1 is a schematic sectional view showing an example of an air secondary battery of the invention.

FIG. 2 is a schematic sectional view showing a cell for evaluation used in Example 1.

### DESCRIPTION OF REFERENCE NUMERALS

1a Anode case
1b Air cathode case
2 Anode current collector
2a Anode lead
3 Anode layer
4 Air cathode layer
5 Air cathode current collector
5a Air cathode lead
6 Separator
7 Nonaqueous liquid electrolyte
8 Microporous film
9 Packing

### BEST MODE FOR CARRYING OUT THE INVENTION

In what follows, an air secondary battery of the invention will be detailed.

An air secondary battery of the invention comprises: an air cathode that has an air cathode layer containing a conductive material and an air cathode current collector that collects a current of the air cathode layer; an anode that has an anode layer containing an anode active material and an anode current collector that collects a current of the anode layer; and a nonaqueous liquid electrolyte that conducts a metal ion between the air cathode layer and the anode layer, wherein the air cathode current collector is formed of a carbon material and the nonaqueous liquid electrolyte containing a sulfonimide salt.

According to the invention, by using an air cathode current collector formed of a carbon material and a nonaqueous liquid electrolyte containing a sulfonimide salt in combination, a charging voltage can be reduced. As is mentioned above, in the case where an air cathode current collector formed of a carbon material is used, while the air cathode current collector can be inhibited from corroding, there is a problem that a charging voltage becomes higher. In the invention, when such an air cathode current collector is combined with a nonaqueous liquid electrolyte containing a sulfonimide salt, a charging voltage can be reduced and thereby charge can be efficiently performed.

In the invention, a reason why the charging voltage can be reduced has not yet been clarified. However, it is considered that, since a nonaqueous liquid electrolyte containing a sulfonimide salt is low in surface tension, wettability of a surface of a carbon material that constitutes an air cathode current collector is improved and thereby ions become readily movable, and a charging reaction (decomposition reaction of discharge product) tends to occur as a result. For example, in the case of a lithium air secondary battery, a discharge product such as Li₂O₂ is generated by discharge. However, it is considered that when the wettability of a surface of a carbon material is improved during charge for decomposing the discharge product, Li ions can smoothly move in the vicinity of the discharge product and thereby a charge reaction tends to occur. Furthermore, as is described below, in the case where a sulfonimide salt has a fluorine element, a nonaqueous liquid electrolyte having high amount of dissolved oxygen is generally obtained. In this case, it is considered that, since more oxygen can be dissolved in a nonaqueous liquid electrolyte, oxygen generated during charge can be removed smoothly from a reaction field of a charge reaction and thereby a charge reaction tends to occur.

A reason why a charging voltage is low in a conventional air secondary battery using a metal air cathode current collector has not yet been clarified. However, it is considered that a metal itself works as a catalyst, and thereby a charge reaction tends to occur. When a metal exerts a catalytic function, the metal may be corroded. On the other hand, it is considered that an air cathode current collector formed of a carbon material does not have a catalytic action and thereby is not corroded but has a high charging voltage.

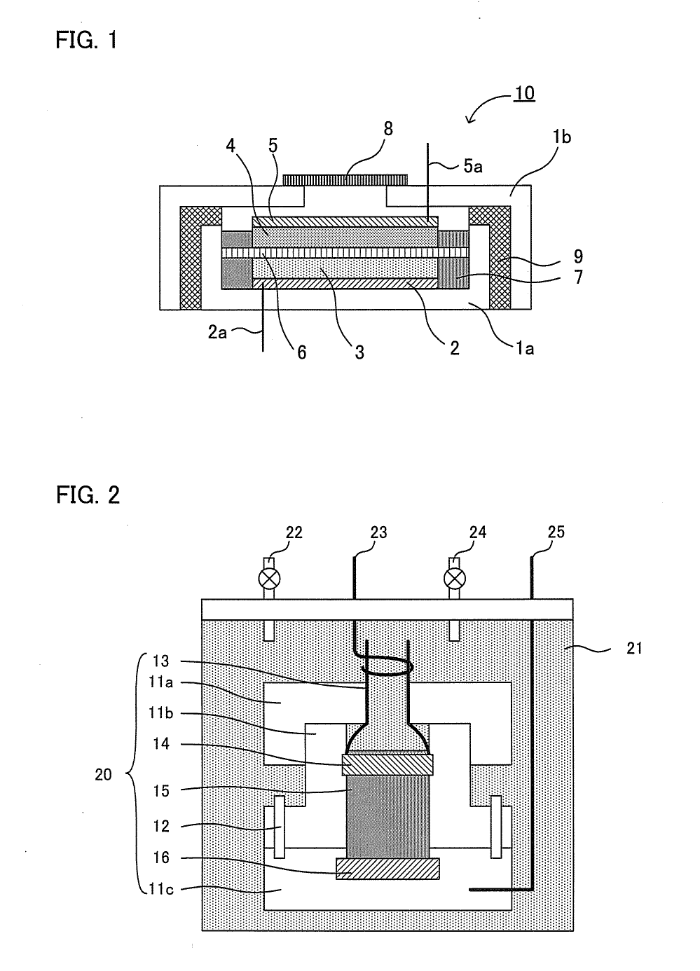

FIG. 1 is a schematic sectional view showing an example of an air secondary battery of the invention. An air secondary battery 10 shown in FIG. 1 comprises: an anode case 1a; an anode current collector 2 formed on an inside bottom surface of the anode case 1a; an anode lead 2a connected to the anode current collector 2; an anode layer 3 formed on the anode current collector 2 and containing an anode active material; an air cathode layer 4 containing a conductive material, a catalyst, and a binder; an air cathode current collector 5 that collects a current of the air cathode layer 4; an air cathode lead 5a connected to the air cathode current collector 5; a separator 6 disposed between the anode layer 3 and the air cathode layer 4; a nonaqueous liquid electrolyte 7 that immerses the anode layer 3 and the air cathode layer 4; an air cathode case 1b having a macroporous film 8; and a packing 9 that hermetically seals a content with the anode case 1a and the cathode case 1b. In the invention, the air cathode current collector 5 is formed of a carbon material and the nonaqueous liquid electrolyte 7 contains a sulfonimide salt.

In what follows, an air secondary battery of the invention will be described for every configuration.

1. Air Cathode

In the beginning, an air cathode used in the invention will be described. The air cathode used in the invention has an air cathode layer containing a conductive material and an air cathode current collector that collects a current of the air cathode layer.

(1) Air Cathode Current Collector

The air cathode current collector used in the invention collects a current of the air cathode layer. Furthermore, the air cathode current collector used in the invention is usually formed of a carbon material. The carbon material has the following advantages: excellent corrosion resistance, excellent electron conductivity, and higher energy density per weight because of its less weight than that of a metal. As such a carbon material, for example, carbon fiber and activated carbon (activated carbon plate) can be cited. Among the above, the carbon fiber is preferable. This is because electrons can be conducted through a fiber and thereby electron conductivity is high. As a kind of the carbon fiber, for example, PAN carbon fiber and pitch carbon fiber can be cited.

A structure of the air cathode current collector in the invention is not particularly restricted as long as desired electron conductivity can be secured. The air cathode current collector may have either a porous structure having gas diffusability or a dense structure that does not have gas diffusability. Above all, in the invention, the air cathode current collector is preferable to have a porous structure having gas diffusability. Specific examples of the porous structure include a mesh structure, a nonwoven fabric structure, and a three-dimensional network structure having connection holes or the like. A porosity of the porous structure is not particularly restricted but is preferable to be in the range of, for example, 20% to 99%.

Examples of the air cathode current collector that uses the carbon fiber include, for example, a carbon cloth and a carbon paper. The carbon cloth is generally obtained by regularly knitting carbon fibers (corresponding to the mesh structure). On the other hand, a carbon paper is usually obtained by randomly arranging carbon fibers (corresponding to the nonwoven fabric structure). Furthermore, the carbon cloth and carbon paper may be obtained by either sintering or activating. Still furthermore, in the invention, the carbon cloth and carbon fibers each may be used in a stacked structure. Thereby it becomes possible to obtain an air cathode current collector having enhanced mechanical strength.

A thickness of the air cathode current collector in the invention is, for example, in the range of 10 μm to 1000 μm and preferably in the range of 20 μm to 400 μm.

(2) Air Cathode Layer

An air cathode layer used in the invention contains at least a conductive material. Furthermore, as required, the air cathode layer may contain at least one of a catalyst and a binder.

The conductive material that is used in the air cathode layer is not particularly restricted as long as it has conductivity. Examples thereof include a carbon material and the like. Furthermore, the carbon material may or may not have a porous structure. However, in the invention, a carbon material having a porous structure is preferable. This is because a specific surface area is large and thereby many reaction fields can be provided. Examples of the carbon material having a porous structure specifically include mesoporous carbon and the like. On the other hand, examples of carbon material not having a porous structure specifically include graphite, acetylene black, carbon nanotube, and carbon fiber. Content of the conductive material in the air cathode layer is preferably in the range of, for example, 10% by weight to 99% by weight. This is because when the content of the conductive material is excessively small, reaction fields are reduced and thereby a battery capacity tends to decrease; on the other hand, when the content of the conductive material is excessively large, contents of a catalyst and a binder decrease relatively and thereby a desired air cathode layer may not be obtained.

Furthermore, the air cathode layer used in the invention may contain a catalyst that accelerates a reaction. This is because an electrode reaction is more smoothly carried out. In particular, it is preferable that a conductive material supports a catalyst. Examples of the catalyst include an oxide catalyst such as manganese dioxide (MnO₂) or cerium dioxide (CeO₂), a large ring compound such as phthalocyanine or polyphyllin, and a complex obtained by coordinating a transition metal (such as Co) to the large ring compound. Content of the catalyst in the air cathode layer is in the range of, for example, 1% by weight to 30% by weight and preferably in the range of 5% by weight to 20% by weight. This is because when the content of a catalyst is too small, a sufficient catalytic function may not be exerted, on the other hand, when the content of the catalyst is too large, content of the conductive material is relatively reduced and reaction fields are reduced, and thereby a battery capacity may be deteriorated.

The air cathode layer used in the invention may contain a binder that immobilizes the conductive material. Examples of the binder include a fluorine-containing binder such as polyvinylidene fluoride (PVDF) or polytetrafluoroethylene (PTFE). Content of the binder in the air cathode layer is, for example, 40% by weight or less and preferably in the range of 1% by weight to 10% by weight.

A thickness of the air cathode layer is different depending on factors such as applications of the air secondary battery. For example, the thickness is in the range of 2 μm to 500 μm and, among these, preferably in the range of 5 μm to 300 μm.

(3) Method for Forming Air Cathode

A method in the invention for forming an air cathode is not particularly restricted as long as it can form the above-mentioned air cathode. As an example of the method for forming an air cathode, a method in which an air cathode layer forming composition containing a conductive material, a catalyst, and a binder is prepared first, then, the composition is coated on an air cathode current collector and dried can be cited.

2. Nonaqueous Liquid Electrolyte

In the next place, a nonaqueous liquid electrolyte used in the invention will be described. The nonaqueous liquid electrolyte used in the invention conducts metal ions between an anode layer and an air cathode layer. Furthermore, the nonaqueous liquid electrolyte usually contains a sulfonimide salt and an organic solvent (nonaqueous solvent). Examples of the sulfonimide salt used in the invention include, for example, compounds represented by a formula (1) shown below. In the formula (1), M represents an alkali metal element and R₁ and R₂ each independently represent a functional group containing a fluorine element and a carbon element. Furthermore, R₁ and R₂ may bind with each other to form a ring structure.

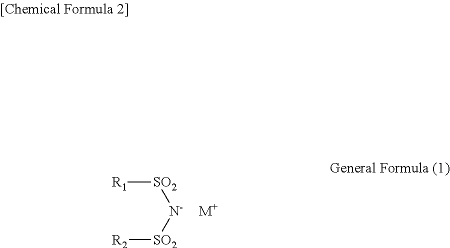

In the formula (I), M represents an alkali metal element, and, usually, the alkali metal ion is a conductive ion of an air secondary battery. Examples of the alkali metal ion include a Li ion, a Na ion and a K ion, among these a Li ion being preferable. This is because a battery high in energy density can be obtained. On the other hand, in the formula (I) R₁ and R₂ each are a functional group containing a fluorine element and a carbon element, among these a functional group constituted of only fluorine elements and carbon elements is preferable. In particular, in the invention, R₁ and R₂ are preferable to be —CₙF₂ₙ₊₁. This is because a charging voltage can be made sufficiently low. A value of “n” is preferable to be 1 to 6 and more preferable to be 1 to 4.

Examples of a sulfonimide salt where M is Li and R₁ and R₂ each are —CₙF₂ₙ₊₁ include specifically (CF₃SO₂)₂NLi (called LiTFSI in some cases), (C₂F₅SO₂)(CF₃SO₂)NLi, (C₂F₅SO₂)₂NLi (called LiBETI in some cases), (C₃F₇SO₂)(CF₃SO₂)NLi, (C₃F₇SO₂)(C₂F₅SO₂)NLi (C₃F₇SO₂)₂NLi, (C₄F₉SO₂)(CF₃SO₂)NLi, (C₄F₉SO₂)(C₂F₅SO₂)NLi, (C₄F₉SO₂)(C₃F₇SO₂)NLi, and (C₄F₉SO₂)₂NLi. Among these, LiTFSI and LiBETI is particularly preferable.

Furthermore, in the formula (I), R₁ and R₂ may bind with each other to form a ring structure. As such a cyclic sulfonimide salt, CF₂(CF₂SO₂)₂NLi and the like can be specifically cited. A concentration of the sulfonimide salt in a nonaqueous liquid electrolyte is, for example, in the range of 0.3 mol/L to 3 mol/L and, above all, preferably in the range of 0.5 mol/L to 2 mol/L.

Examples of the organic solvent include ethylene carbonate (EC), propylene carbonate (PC), dimethyl carbonate (DMC), diethyl carbonate (DEC), ethyl methyl carbonate (EMC), butylene carbonate, γ-butylolactone, sulfolane, acetonitrile, 1,2-dimethoxymethane, 1,3-dimethoxypropane, diethyl ether, tetrahydrofuran, 2-methyl tetrahydrofuran and mixtures thereof. The organic solvent is preferable to be a solvent high in oxygen solubility. This is because dissolved oxygen can be efficiently used in a reaction. In the invention, an ionic liquid (molten salt at room temperature) may be used as a solvent.

Furthermore, a nonaqueous liquid electrolyte used in the invention may be used, as a nonaqueous gel electrolyte by adding a polymer thereto. For example, a nonaqueous gel electrolyte of a lithium air secondary battery can be obtained by adding a polymer such as polyethylene oxide (PEO), polyacrylnitrile (PAN) or polymethyl methacrylate (PMMA) to the nonaqueous liquid electrolyte and thereby gelling the nonaqueous liquid electrolyte.

3. Anode

In the next place, an anode used in the invention will be described. The anode used in the invention contains an anode layer containing an anode active material and an anode current collector that collects a current of the anode layer.

(1) Anode Layer

The anode layer used in the invention contains at least an anode active material. The anode active material is not particularly restricted as long as it can absorb and release metal ions. Examples of the anode active material include metal alone, alloys, metal oxides and metal nitrides. Examples of the metal ion include an alkali metal ion. Furthermore, examples of the alkali metal ion include a Li ion, a Na ion and a K ion, and among these, a Li ion is particularly preferred. This is because a battery having high energy density can be obtained.

Examples of an alloy containing a lithium element include lithium-aluminum alloys, lithium-tin alloys, lithium-lead alloys, and lithium-silicon alloys. Furthermore, examples of a metal oxide containing a lithium element include lithium titanate. Still furthermore, examples of a metal nitride containing a lithium element include, for example, lithium cobalt nitride, lithium iron nitride, and lithium manganese nitride.

Furthermore, an anode layer used in the invention may contain either an anode active material alone or at least one of a conductive material and a binder in addition to the anode active material. For example, when an anode active material is flaky, an anode layer may contain an anode active material alone. On the other hand, when an anode active material is powdery, an anode layer may contain a conductive material and a binder. The conductive material and the binder are the same as that described in the “1. Air cathode”; accordingly descriptions thereof are omitted here. Furthermore, a thickness of an anode layer is preferable to be appropriately selected in accordance with a configuration of a target air secondary battery.

(2) Anode Current Collector

The anode current collector used in the invention collects a current of an anode layer. A material of the anode current collector is not particularly restricted as long as it has conductivity. Examples of the material of the anode current collector include copper, stainless or nickel. Examples of a shape of the anode current collector include a flaky shape, a planar shape and a meshed (grid) shape. In the invention, a battery case described below may combine a function of an anode current collector. A thickness of the anode current collector is preferable to be appropriately selected in accordance with a configuration of a target air secondary battery.

(3) Method for Forming Anode

A method of the invention for forming an anode is not particularly restricted as long as it can form the above-mentioned anode. As an example of a method for producing an anode, a method in which a flaky anode active material is disposed on an anode current collector, followed by pressurizing can be cited. Furthermore, as another example of a method for producing an anode, a method where an anode layer-forming composition containing an anode active material and a binder is prepared, then, the composition is coated on an anode current collector, followed by drying can be cited.

4. Battery Case

In the next place, a battery case used in the invention will be described. A shape of a battery case used in the invention is not particularly restricted as long as it can house an air cathode, an anode, and a nonaqueous liquid electrolyte, which were described above. Examples of the shape of the battery case specifically include a coin shape, a plain plate shape, a cylindrical shape, and a laminate shape. Furthermore, the battery case may be either an open atmospheric type battery case or a hermetically sealed battery case. The open atmospheric type battery case is, as is shown in the FIG. 1, a battery case that can come into contact with the atmosphere. On the other hand, when the battery case is a hermetically sealed battery case, it is preferable that the hermetically sealed battery case is provided with a gas (air) inlet tube and a gas (air) outlet tube. In this case, a gas that is introduced and exhausted is preferable to be high in oxygen concentration and more preferable to be pure oxygen. Furthermore, it is preferable that an oxygen concentration is made higher during discharge and lower during charge.

5. Air Secondary Battery

An air secondary battery of the invention is preferable to have a separator that holds a nonaqueous liquid electrolyte between an air cathode layer and an anode layer. This is because an air secondary battery higher in safety can be obtained. Examples of the separator include porous films made of polyethylene or polypropylene; and nonwoven fabrics such as resin nonwoven fabrics or glass fiber nonwoven fabrics. A thickness of the separator is preferable to be selected appropriately in accordance with an application of an air secondary battery.

Furthermore, a kind of an air secondary battery of the invention varies depending on a kind of a metal ion that is a conductive ion. As the metal ion, for example, alkali metal ions can be cited. Examples of the alkali metal ion include a Li ion, a Na ion and a K ion, and among these, a Li ion is preferable. That is, examples of kind of an air secondary battery of the invention include a lithium air secondary battery, a sodium air secondary battery and a potassium air secondary battery, and, among these, a lithium air secondary battery is preferable. This is because a battery high in energy density can be obtained. Examples of application of the air secondary battery of the invention include, for example, an in-car battery, a stationary power supply battery and a home power supply battery. A method of the invention for producing an air secondary battery is, without restricting to particular one, the same as that of a general air secondary battery.

The present invention is not restricted to the above-described exemplary embodiments. The exemplary embodiments are shown only for illustration and whatever that has a substantially same configuration with a technical idea described in what is claimed of the invention and exerts an effect the same as that described above is included in a technical range of the invention.

### EXAMPLES

In what follows, the invention will be more specifically described.

### Example 1

### Preparation of Air Cathode

In the beginning, 85 parts by weight of Ketjen Black (manufactured by Ketjen Black International Corporation), 15 parts by weight of electrolytic manganese dioxide (manufactured by Kojundo Chemical Laboratory Co., Ltd.) and 100 parts by weight of PVDF solution (manufactured by Kureha Corporation) were mixed, NMP (N-methylpyrrolidone, manufactured by Kanto Kagaku) was added thereto, followed by mixing with a kneader, and thereby an air cathode layer-forming paste was obtained. Thereafter, the air cathode layer-forming paste was coated on a carbon paper (air cathode current collector, TGP-H-090, manufactured by Toray industries, INC, thickness: 0.28 mm), followed by drying to remove NMP, further followed by punching into a φ of 18 mm, and thereby an air cathode was obtained.

(Assembly of Lithium Air Secondary Battery)

In the next place, a lithium air secondary battery that uses the resulted air cathode was prepared (see FIG. 2). The battery was all assembled in an argon box (dew point: −40° C. or lower). Here, a lithium air secondary battery 20 has battery cases 11a and 11b made of Teflon (registered trade mark) and a SUS battery case 11c. The battery case 11b and the battery case 11c are connected with a bolt 12. Furthermore, the battery case 11a has an opening for supplying oxygen and to the opening, a hollow current output portion 13 is disposed. Still furthermore, the air cathode obtained according to the method mentioned above was used for an air cathode 14, a nonaqueous liquid electrolyte obtained by dissolving (CF₃SO₂)₂NLi at a concentration of 1 M in propylene carbonate (PC) was used for a nonaqueous liquid electrolyte 15, and metal lithium (manufactured by Honjo Metal Co., Ltd., thickness: 200 μm, diameter: 19 mm) was used for an anode layer 16. The nonaqueous liquid electrolyte 15 was added to an extent where a top portion of the air cathode 14 is dipped.

(Preparation of Cell for Evaluation)

Then, an air cathode lead 23 was connected to a SUS current output portion 13, an anode lead 25 was connected to the SUS battery case 11c and the lithium air secondary battery 20 was housed in a glass container 21 having a volume of 1000 cc. Thereafter, the glass container 21 was hermetically sealed, and the hermetically sealed glass container 21 was taken out of the inside of the argon box. In the next place, oxygen was introduced from an oxygen gas bomb through a gas inlet 22, simultaneously therewith the inside of the glass container was exhausted from a gas outlet 24, and thereby the inside of the glass container was changed from an argon atmosphere to an oxygen atmosphere. Thereby, a cell for evaluation was obtained.

### Example 2

A cell for evaluation was obtained in a manner similar to Example 1 except that in a nonaqueous liquid electrolyte 15, in place of (CF₃SO₂)₂NLi, (C₂F₅SO₂)₂NLi was used.

### Comparative Example 1

A cell for evaluation was obtained in a manner similar to Example 1 except that in a nonaqueous liquid electrolyte 15, in place of (CF₃SO₂)₂NLi, LiClO₄ was used.

### Comparative Example 2

A cell for evaluation was obtained in a manner similar to Example 1 except that in a nonaqueous liquid electrolyte 15, in place of (CF₃SO₂)₂NLi, LiPF₆ was used.

[Evaluation]

A charge-discharge test was performed with each of the cells for evaluation obtained in Examples 1 and 2 and Comparative examples 1 and 2. Charge-discharge conditions are shown below. The charge-discharge was started from discharge and performed in a thermostat bath at 25° C.

(1) Discharge is performed at a current of 100 mA/(g-carbon) up to a battery voltage of 2 V,
(2) after discharge, rest for 1 hour, and
(3) after rest, charge is performed at a current of 100 mA/(g-carbon) up to a battery voltage of 4.3 V.

Here, “g-carbon” represents a weight of powder carbon. Obtained results are shown in Table 1.

TABLE 1

| | | | | Charge capacity |
|---|---|---|---|---|
| | Discharged capacity | Charge capacity | | at 5th cycle/ |
| | at 1st cycle | at 1st cycle | C1/D1 | charge capacity |
| | D1(mAh/g-carbon) | C1(mAh/g-carbon) | (%) | at 1st cycle (%) |
| Example 1 | 6830 | 6820 | 100 | 100 |
| Example 2 | 6850 | 6840 | 100 | 100 |
| Comparative | 4560 | 3550 | 78 | 90 |
| Example 1 | | | | |
| Comparative | 4210 | 2540 | 60 | 83 |
| Example 2 | | | | |

As is shown in Table 1, in each of Examples 1 and 2, charge capacity at the 1st cycle was substantially 100% relative to discharged capacity at the 1st cycle. On the other hand, in Comparative Examples 1 and 2, charge capacities at the 1st cycle, respectively, were 78% and 60% relative to discharged capacities at the 1st cycle. In particular, when LiPF₆ was used (Comparative Example 2), efficiency of charge to discharge was low. This is considered that a side reaction product such as LiF was generated.

In Examples 1 and 2, a reason why an efficiency of charge is superior to that of discharge is considered that charging voltages are lower than that of Comparative Examples 1 and 2. In Comparative Examples 1 and 2, it is considered that since charging voltages thereof are high and rapidly reach 4.3 V during charge, efficiencies of charge relative to those of discharge were deteriorated. A reason why the charging voltage becomes lower is considered that since, as is mentioned above, a nonaqueous liquid electrolyte containing a sulfonimide salt has low in surface tension, wettability of a surface of a carbon material constituting an air cathode current collector is improved and thereby ions move smoothly, and thereby a charge reaction (decomposition reaction of discharge product) tends to occur.

Furthermore, as is shown in Table 1, it was found that, in Examples 1 and 2, charge capacities at the fifth cycle are substantially the same (substantially 100%) as those of the 1st cycle and air secondary batteries of the invention exhibit excellent cycle properties.

1. An air secondary battery, comprising:
an air cathode having an air cathode layer containing a conductive material and an air cathode current collector that collects a current of the air cathode layer; an anode having an anode layer containing an anode active material and an anode current collector that collects a current of the anode layer; and a nonaqueous liquid electrolyte that conducts a metal ion between the air cathode layer and the anode layer;
wherein the air cathode current collector is formed of a carbon material; and
the nonaqueous liquid electrolyte contains a sulfonimide salt.

2. The air secondary battery of claim 1, wherein the sulfonimide salt is a compound represented by a formula (1) shown below: 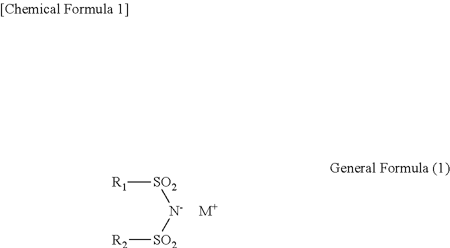
(in the formula (1), M represents an alkali metal element, R₁ and R₂ each independently represent a functional group containing a fluorine element and a carbon element, and R₁ and R₂ may bind with each other to form a ring structure.)

3. The air secondary battery of claim 1, wherein the carbon material is a carbon fiber.

4. The air secondary battery of claim 3, wherein the air cathode current collector is a carbon paper or a carbon cloth that uses the carbon fiber.

5. The air secondary battery of claim 1, wherein the metal ion is a Li ion.
